(19) United States
(12) Patent Application Publication
(10) Pub. No.: US 2026/0131829 A1
(43) Pub. Date: May 14, 2026

(54) Method and Device for Disabling an Automated Driving Function of a Vehicle

(71) Applicant: Bayerische Motoren Werke Aktiengesellschaft, Muenchen (DE)

(72) Inventors: Bernhard DEHLINK, Muenchen (DE); Maltiza IVANOVA, Muenchen (DE)

(21) Appl. No.: 19/115,824

(22) PCT Filed: Sep. 1, 2023
(86) PCT No.: PCT/EP2023/074054

§ 371 Date: Mar. 27, 2025

(30) Foreign Application Priority Data
Sep. 29, 2022 (DE) 10 2022 125 086.5

(51) Int. Cl. B60W 60/00; B60W 50/14

(52) U.S. Cl. CPC B60W 60/0053; B60W 50/14; B60W 60/0015; B60W 2552/35; B60W 2552/40; B60W 2552/53; B60W 2554/20; B60W 2554/4029; B60W 2554/4041; B60W 2554/4044; B60W 2555/20; B60W 2556/45; B60W 2556/65

(57) ABSTRACT

The present disclosure relates to a device for controlling an automated driving function of a vehicle. The device is designed to detect an obstruction event lying ahead in the direction of travel of the vehicle and to determine a spatial extent of an obstruction area for the detected obstruction event depending on an event type of the detected obstruction event. The device is also designed to ensure that the automated driving function cannot be used in the obstruction area.

### BACKGROUND AND SUMMARY

The present disclosure relates to a method and a corresponding device which are geared to controlling the use of an automated driving function of a vehicle.

A vehicle may have one or more automated driving functions each designed to longitudinally and/or laterally guide the vehicle in an at least partially or completely automated manner. It may possibly not be permissible to use a driving function if one or more usage conditions for using the driving function are not met in a driving situation of the vehicle, for example if the road used by the vehicle does not have any lane markings.

If it is identified during the driving mode of the vehicle that an automated driving function currently being used can no longer be used (for example because a usage condition is no longer met), a takeover request can be output to the driver of the vehicle, in which the driver is requested to manually take over the driving task. The takeover request should not be made too late in order to enable a safe takeover, but also should not be made too early in order to enable comfortable use of the vehicle. In a corresponding manner, it should already be identified in good time that a driving function cannot be used, in order to prevent the driving function from being activated.

The present document deals with a technical object of achieving safe and particularly comfortable operation of an automated driving function of a vehicle.

This object is achieved by aspects of the present disclosure. Advantageous embodiments are described, inter alia, in the disclosure.

One aspect describes a device for controlling an automated driving function of a vehicle. The driving function may be designed to longitudinally and/or laterally guide the vehicle in an at least partially or completely automated manner (for example according to SAE level 3).

The device is configured to detect an obstruction event ahead in the direction of travel of the vehicle. The device may be configured, for example, to determine, in particular receive, data relating to the obstruction event. The data may comprise Real Time Traffic Information (RTTI) data and/or a vehicle-to-X, in particular a vehicle-to-vehicle or a vehicle-to-infrastructure, message. The obstruction event can then be detected based on the determined, in particular received, data. The determined, in particular received, data may also indicate the position of the obstruction event and/or the event type of the obstruction event.

The device is also configured to determine the spatial extent of an obstruction region for the detected obstruction event based on the event type of the detected obstruction event. The spatial extent of the obstruction region may comprise the length of the obstruction region in the direction of travel or may correspond to the length of the obstruction region in the direction of travel. Different spatial extents may be determined for different event types.

The event type of the detected obstruction event may be an event type from a multiplicity of different, predefined event types. The multiplicity of different, predefined event types may comprise, for example:
at least one event type for a weather condition present at a position of the road used by the vehicle, in particular rain, fog, sleet or snow; and/or
at least one event type for a person located at a position on the road; and/or
at least one event type for an object located at a position on the road; and/or
at least one event type for a road condition present at a position of the road, in particular a pothole or an icy road surface or a missing road marking; and/or
at least one event type for a natural disaster present at a position of the road, in particular a landslide; and/or
at least one event type for another road user driving in the wrong direction of travel (e.g. wrong-way driver).

The different event types may be associated with different spatial extents for the obstruction region. The device may be configured to determine the spatial extent of the obstruction region for the detected obstruction event based on an assignment function which, for the multiplicity of different event types, indicates the spatial extent of the obstruction region for an obstruction event of the respective event type. The assignment function may comprise or be, for example, a lookup table. The spatial extent of the obstruction region can thus be determined in a particularly efficient and reliable manner.

The different event types may differ from one another in terms of
the accuracy with which the position of an obstruction event of the respective event type can be determined; the accuracy of the position may depend, for example, on the capture accuracy at the capture time, for example of current weather conditions. Alternatively or additionally, the obstruction event may possibly have its own movement, and so the accuracy of the position depends, for example, on how far in the past the capture time is; and/or
the severity of a possible harmful effect that an obstruction event of the respective event type has on the vehicle, on an occupant of the vehicle and/or on another road user.

The device may be configured to determine the spatial extent of the obstruction region for the detected obstruction event based on the event type of the detected obstruction event in such a manner that
the spatial extent of the obstruction region increases with decreasing accuracy (of the position of obstruction events) of the respective event type; and/or
the spatial extent of the obstruction region increases with increasing severity (of a possible effect of obstruction events) of the respective event type.

The above-mentioned relationship between the accuracy and/or the severity and the spatial extent of the obstruction region may be stored, for example, in the above-mentioned assignment function.

The device may possibly be configured to determine the spatial extent of the obstruction region for the detected obstruction event with the involvement of a unit outside the vehicle. For example, a relevant request may be sent to the unit outside the vehicle. The spatial extent of the obstruction region can then be determined by the unit outside the vehicle and transmitted to the device.

The device is also configured to cause the automated driving function to not be able to be used in the obstruction region (at least in certain areas and, if possible, in the entire obstruction region).

For this purpose, the device may be configured to output a takeover request to the driver of the vehicle (in order to request the driver to manually take over the driving task) before reaching the determined obstruction region for the detected obstruction event, and to deactivate the automated driving function at the beginning of the determined obstruction region. The takeover request may be output, for example, a certain transfer period before reaching the beginning of the determined obstruction region.

Alternatively or additionally, the device may be configured to prevent the automated driving function from being able to be activated as long as the vehicle is within the determined obstruction region for the detected obstruction event.

Alternatively or additionally, the device may be configured to output a takeover request to the driver of the vehicle and to deactivate the automated driving function (immediately) after expiry of the predefined transfer period, in particular when the vehicle is already within the determined obstruction region for the detected obstruction event. This makes it possible to ensure that the driving function cannot be used at least for the remaining part of the obstruction region.

A description is therefore given of a device which is designed to define the obstruction region, in particular the length and/or the radius of the obstruction region, for an obstruction event in a type-dependent manner. The safety and comfort of an automated driving function can therefore be increased.

The device may be configured to determine the position of the detected obstruction event. The spatial extent of a section in the direction of travel before the position of the detected obstruction event and/or the spatial extent of a section in the direction of travel after the position of the detected obstruction event can then be determined based on the event type of the detected obstruction event. The obstruction region for the detected obstruction event can then be determined in a particularly precise and flexible manner based on the section before and/or based on the section after the position of the detected obstruction event. The comfort and safety of the automated driving function can therefore be increased further.

A further aspect describes a (road) motor vehicle (in particular an automobile or a truck or a bus or a motorcycle) which comprises the device described in this document.

A further aspect describes a unit outside the vehicle (for example a backend server) which comprises the device described in this document. An obstruction event ahead in the direction of travel of a vehicle can be detected by the unit outside the vehicle. For example, it is possible to identify that there is an obstruction event on or in the surroundings of the route of the vehicle. Furthermore, the spatial extent of the obstruction region for the detected obstruction event can be determined (based on the event type of the detected obstruction event). Furthermore, it is possible to cause an automated driving function of the vehicle to not be able to be used in the obstruction region. For this purpose, data relating to the determined spatial extent of the obstruction region can be sent to the vehicle. Use of the automated driving function can then be prevented by a control unit of the vehicle.

A further aspect describes a method for controlling an automated driving function of a vehicle. The method comprises detecting an obstruction event ahead in the direction of travel of the vehicle, and determining a spatial extent of the obstruction region for the detected obstruction event based on an event type of the detected obstruction event, wherein the spatial extent may be different for different event types. The method also comprises causing the automated driving function to not be able to be used in the obstruction region (at least in certain areas or preferably in the entire obstruction region).

A further aspect describes a software (SW) program. The SW program may be configured to be executed on a processor (for example on a control unit of a vehicle) in order to thereby carry out the method described in this document.

A further aspect describes a storage medium. The storage medium may comprise a SW program which is configured to be executed on a processor and to thereby carry out the method described in this document.

In the context of the document, the term “automated driving” can be understood as driving with automated longitudinal or lateral guidance or autonomous driving with automated longitudinal and lateral guidance. Automated driving may involve, for example, driving on the freeway for a relatively long time or driving for a limited time in the context of parking or maneuvering. The term “automated driving” encompasses automated driving with an arbitrary degree of automation. Exemplary degrees of automation are assisted, partially automated, highly automated or fully automated driving. These degrees of automation were defined by the German Federal Highway Research Institute (BASt) (see BASt publication “Forschung kompakt”, issue November 2012). For assisted driving, the driver permanently carries out the longitudinal or lateral guidance, while the system performs the respective other function within certain limits. For partially automated driving (PAD), the system performs the longitudinal and lateral guidance for a certain period of time and/or in specific situations, wherein the driver must permanently monitor the system as for assisted driving. For highly automated driving (HAD), the system performs the longitudinal and lateral guidance for a certain period of time, without the driver having to permanently monitor the system; however, the driver must be able to take over guidance of the vehicle within a certain time. For fully automated driving (FAD), the system can automatically manage driving in all situations for a specific application; a driver is no longer required for this application. The four degrees of automation mentioned above correspond to SAE levels 1 to 4 of the SAE J 3016 standard (SAE—Society of Automotive Engineering). By way of example, highly automated driving (HAD) corresponds to level 3 of the SAE J 3016 standard. Furthermore, the SAE J 3016 also provides SAE level 5 as the highest degree of automation, which is not contained in the definition by the BASt. SAE level 5 corresponds to driverless driving, during which the system can automatically manage all situations like a human driver during the entire journey; a driver is generally no longer required. The measures described in this document relate, in particular, to a driving function according to SAE level 3.

It should be noted that the methods, devices and systems described in this document can be used both alone and in combination with other methods, devices and systems described in this document. Furthermore, any aspects of the methods, devices and systems described in this document can be combined with one another in various ways. Furthermore, features in parentheses should be understood as optional features.

The present disclosure is described in more detail below using exemplary embodiments.

### BRIEF DESCRIPTION OF THE DRAWINGS

FIG. 1 shows exemplary components of a vehicle;

FIG. 2 shows an exemplary driving situation with an obstruction event ahead; and

FIG. 3 shows a flowchart of an exemplary method for disabling an automated driving function of a vehicle.

### DETAILED DESCRIPTION OF THE DRAWINGS

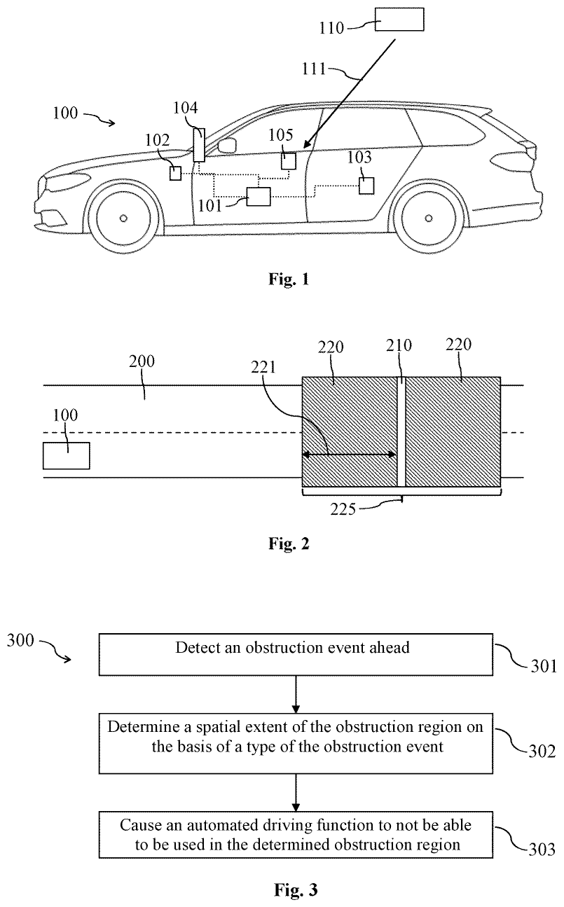

As explained at the outset, the present document deals with increasing the comfort and safety of an automated driving function of a vehicle. In this context, FIG. 1 shows an exemplary vehicle 100 which comprises one or more environmental sensors 102 each configured to capture sensor data relating to the environment of the vehicle 100. Exemplary environmental sensors 102 are radar sensors, lidar sensors, ultrasonic sensors, cameras, etc.

A (control) device 101 of the vehicle 100 may be configured to evaluate the sensor data from the one or more environmental sensors 102, for example in order to detect one or more objects in the environment of the vehicle 100 and/or to determine the course of the road used by the vehicle 100. The device 101 may also be configured to operate one or more longitudinal and/or lateral guidance actuators 103 of the vehicle 100 (for example a drive motor, a brake device and/or a steering device) based on the (evaluated) sensor data from the one or more environmental sensors 102 in order to provide an automated driving function, during which the vehicle 100 is longitudinally and/or laterally guided in an at least partially or completely automated manner.

The device 101 may also be configured to identify that there is an obstruction event ahead on the road used by the vehicle 100. The obstruction event may be present at a particular position of the road. The obstruction event may be a static event, for example a construction site. Data relating to an obstruction event may be recorded in a digital map for the road network used by the vehicle 100 (for example as a map attribute). Alternatively or additionally, the obstruction event ahead may be detected based on the sensor data from the one or more environmental sensors 102 of the vehicle 100.

The device 101 may be configured to cause automated driving function of the vehicle 100 to not be used in an obstruction region ahead around the position of the obstruction event. For this purpose, a takeover request can be output to the driver of the vehicle 100 via a user interface 104 of the vehicle 100 in order to prompt the driver of the vehicle 100 to manually longitudinally and/or laterally guide the vehicle 100. The takeover request should not be made too close to the obstruction event in order to enable a safe takeover by the driver, and should not be made too far ahead of the obstruction event in order to enable comfortable operation of the automated driving function.

The vehicle 100 may comprise a communication unit 105 which is configured to receive data 111 relating to an obstruction event from a unit 110 outside the vehicle. The data 111 may be received via wireless communication (for example 3G, 4G, 5G or via a radio channel). The data 111 may comprise, in particular, RTTI (Real Time Traffic Information) data. The data 111 may comprise, in particular, information relating to a dynamic obstruction event, for example a particular weather situation, an obstacle on the road, and/or a wrong-way driver, that is not recorded in a digital map.

FIG. 2 shows an exemplary driving situation in which the vehicle 100 is driving on a road 200 toward an obstruction event, in particular the position 210 of an obstruction event. The obstruction event may be an obstruction event that was identified based on received data 111. The data 111 relating to the obstruction event may indicate
the position 210 (which, for a spatially extended obstruction event, can correspond to the position at which the obstruction event begins);
the event type from a set of different, predefined event types. Exemplary event types are: a particular weather situation (for example heavy rain, fog, etc.); a particular road condition (for example a pothole, an icy road, etc.); a person on the road; an object on the road; a wrong-way driver; etc.

The device 101 may be configured to determine, based on the event type of the obstruction event, an obstruction region 225 for the obstruction event, in which the automated driving function is intended to be disabled. The obstruction region 225 may be a section 220 (in the direction of travel of the vehicle 100) before the position 210 and/or a section 220 (in the direction of travel of the vehicle 100) after the position 210 of the obstruction event.

The device 101 may be configured, in particular, to determine the radius or the length 221 of the obstruction region 225, in particular of the one or more sections 220, based on the event type. For this purpose, it is possible to use a predefined assignment function (for example in the form of a table) which assigns a region length 221 to each of the different event types. The region length 221 typically increases with increasing criticality of the obstruction event for the driving mode of the vehicle 100.

It should be pointed out that the obstruction event is possibly not directly on the route of the vehicle 100 (but rather beside the route). However, determining an obstruction region 225 with a particular radius around the obstruction event (that is to say determining a circular obstruction region 225 around the obstruction event) may result in a situation in which at least one part of the obstruction region 225 is on the route of the vehicle 100.

An automated driving function, for example an SAE level 3 autopilot, typically has a defined ODD (Operational Design Domain) which specifies the boundary or usage conditions under which the automated driving function can be activated by a user. Dynamic events, for example a poor weather situation, a natural disaster or a wrong-way driver, may constitute an increased safety risk and in particular may be such that it is not possible to use a fixed, event-encompassing obstruction radius 221 for disabling the driving function since, depending on the event type, different inaccuracies can occur in the specific localization of the respective event. For this reason, different obstruction radii 221 are preferably used for the purpose of increasing the safety and comfort, in which the respective obstruction radii 221 may be based on the criticality and/or the range (that is to say the spatial extent) of events of the respective event type.

Obstruction radii 221 of different sizes may be determined for the respective event type based on critical event types which are intended to result in the driving function being temporarily disabled. These obstruction radii 221 (or the resulting obstruction regions 225) prevent the autonomous driving function from being enabled for the predefined radius 221 or initiate a takeover request if the vehicle 100 is already within the obstruction radius 221 (that is to say within the corresponding obstruction region 225) while the event occurs. The event types may be assigned to predefined obstruction radii or spatial extents 221 in a backend system 110 and, as soon as an event of the respective event type occurs, the information with the associated route section 225 within the radius 221 can be reported to the vehicle 100. In other words, the spatial extent 221 of the obstruction region 225 for an obstruction event may possibly be determined by a unit 110 outside the vehicle.

After determining the obstruction region 225, the vehicle 100 may initiate a takeover request if the current geo-position of the vehicle 100 is on the invalid and/or obstructed route section or the route section 225 is obstructed and the autonomous driving function is no longer available to the user in this route section 225.

As the event, a wrong-way driver in the lane 200 of a freeway used by the vehicle 100 can be reported, for example. For a wrong-way driver, the surrounding traffic does not behave normally and the automated driving function is possibly not designed to also be able to process oncoming traffic on a freeway. Short-term evasive maneuvers must be carried out if necessary in order to avoid a potential collision. For this reason, a relatively large obstruction radius 221 is preferably assigned to an event of the “wrong-way driver” type since the information 111 relating to the event may possibly be out-of-date and the wrong-way driver may possibly not be accurately located. The safety of the vehicle 100 can be increased by transferring the driving task to the driver in good time.

FIG. 3 shows a flowchart of a (possibly computer-implemented) method 300 for controlling an automated driving function of a (motor) vehicle 100. The automated driving function may be designed to longitudinally and/or laterally guide the vehicle 100 in an at least partially or completely automated manner (for example according to SAE level 3).

The method 300 comprises detecting 301 a (dynamic) obstruction event ahead in the direction of travel of the vehicle 100. The obstruction event may be identified, for example, based on received data 111, in particular based on received RTTI data.

The method 300 also comprises determining 302 the spatial extent 221 of the obstruction region 225, in particular the length or the radius around the position 210 of the obstruction event, for the detected obstruction event based on the event type of the detected obstruction event. The event type can be determined, for example, based on the received data 111. The event type may be a type from a predefined set and/or list of event types. The spatial extent 221 may be determined based on a predefined assignment function (for example by a unit 110 outside the vehicle and/or by a device 101 of the vehicle 100).

The method 300 also comprises causing 303 the automated driving function to not be able to be used (at least in certain areas and preferably completely) in the obstruction region 225. For this purpose, it is possible to cause the activation of the driving function to be blocked within the obstruction region 225. It is also possible to cause the driving function to be deactivated upon reaching the obstruction region 225 or to be deactivated (when the vehicle 100 is already in the obstruction region 225) immediately (after expiry of a transfer period for transferring the driving task to the driver of the vehicle 100).

The measures described in this document make it possible to achieve particularly safe and comfortable operation of an automated driving function.

The present disclosure is not restricted to the exemplary embodiments shown. In particular, it should be noted that the description and the figures are intended to illustrate only by way of example the principle of the proposed methods, devices and systems.

1-10. (canceled)

11. A device for controlling an automated driving function of a vehicle, comprising:
a non-transitory storage medium configured to store a software program; and
a processor configured to execute the stored software program that, when executed, is configured to cause the processor to:
detect an obstruction event ahead in a direction of travel of the vehicle;
determine a spatial extent of an obstruction region for the detected obstruction event based on an event type of the detected obstruction event; and
cause the automated driving function to not be able to be used in the obstruction region.

12. The device according to claim 11, wherein the stored software program is further configured to cause the processor to:
determine a position of the detected obstruction event;
determine a spatial extent of a section in the direction of travel before the position of the detected obstruction event and/or to determine a spatial extent of a section in the direction of travel after the position of the detected obstruction event based on the event type of the detected obstruction event; and
determine the obstruction region for the detected obstruction event based on the section before and/or based on the section after the position of the detected obstruction event.

13. The device according to claim 11, wherein the spatial extent of the obstruction region comprises a length of the obstruction region in the direction of travel or corresponds to the length of the obstruction region in the direction of travel.

14. The device according to claim 11, wherein the stored software program is further configured to cause the processor to:
determine the spatial extent of the obstruction region for the detected obstruction event based on an assignment function which, for a multiplicity of different event types, indicates the spatial extent of the obstruction region for an obstruction event of the respective event type.

15. The device according to claim 11, wherein
the event type of the detected obstruction event is an event type from a multiplicity of different, predefined event types;
the different event types differ from one another in terms of an accuracy with which a position of an obstruction event of the respective event type can be determined and/or a severity of a possible harmful effect that an obstruction event of the respective event type has on the vehicle, on an occupant of the vehicle and/or on another road user; and
the stored software program is further configured to cause the processor to determine the spatial extent of the obstruction region for the detected obstruction event based on the event type of the detected obstruction event in such a manner that the spatial extent of the obstruction region increases with decreasing accuracy of the event type and/or the spatial extent of the obstruction region increases with increasing severity of the event type.

16. The device according to claim 11, wherein the event type of the detected obstruction event is an event type from a plurality of predefined event types, comprising:
a weather condition present at a position of a road, the weather condition comprising rain, fog, sleet or snow;
a person located at a position of the road;
an object located at a position of the road;
a road condition present at a position of the road, the road condition comprising a pothole, an icy road surface, or a missing road marking;
a natural disaster present at a position of the road, the natural disaster comprising a landslide; and/or
another road user driving in a wrong direction of travel.

17. The device according to claim 11, wherein the stored software program is further configured to cause the processor to:
receive data relating to the obstruction event; and
detect the obstruction event based on the received data.

18. The device according to claim 17, wherein the data comprises Real Time Traffic Information (RTTI) data, a vehicle-to-vehicle message, or a vehicle-to-infrastructure message.

19. The device according to claim 11, wherein the stored software program is further configured to cause the processor to:
output a takeover request to a driver of the vehicle before reaching the determined spatial extent of the obstruction region for the detected obstruction event, and to deactivate the automated driving function at a beginning of the determined spatial extent of the obstruction region;
prevent the automated driving function from being able to be activated as long as the vehicle is within the determined spatial extent of the obstruction region for the detected obstruction event; and/or
output a takeover request to the driver of the vehicle and to deactivate the automated driving function after expiry of a predefined transfer period.

20. The device according to claim 19, wherein expiry of the predefined transfer period corresponds to the vehicle already being within the determined spatial extent of the obstruction region for the detected obstruction event.

21. A method for controlling an automated driving function of a vehicle, comprising:
detecting an obstruction event ahead in a direction of travel of the vehicle;
determining a spatial extent of an obstruction region for the detected obstruction event based on an event type of the detected obstruction event; and
causing the automated driving function to not be able to be used in the obstruction region.

22. The method according to claim 21, further comprising:
determining a position of the detected obstruction event;
determining a spatial extent of a section in the direction of travel before the position of the detected obstruction event and/or to determine a spatial extent of a section in the direction of travel after the position of the detected obstruction event based on the event type of the detected obstruction event; and
determining the obstruction region for the detected obstruction event based on the section before and/or based on the section after the position of the detected obstruction event.

23. The method according to claim 21, wherein the spatial extent of the obstruction region comprises a length of the obstruction region in the direction of travel or corresponds to the length of the obstruction region in the direction of travel.

24. The method according to claim 21, further comprising:
determining the spatial extent of the obstruction region for the detected obstruction event based on an assignment function which, for a multiplicity of different event types, indicates the spatial extent of the obstruction region for an obstruction event of the respective event type.

25. The method according to claim 21, wherein
the event type of the detected obstruction event is an event type from a multiplicity of different, predefined event types;
the different event types differ from one another in terms of an accuracy with which a position of an obstruction event of the respective event type can be determined and/or a severity of a possible harmful effect that an obstruction event of the respective event type has on the vehicle, on an occupant of the vehicle and/or on another road user; and
the method further comprises determining the spatial extent of the obstruction region for the detected obstruction event based on the event type of the detected obstruction event in such a manner that the spatial extent of the obstruction region increases with decreasing accuracy of the event type and/or the spatial extent of the obstruction region increases with increasing severity of the event type.

26. The method according to claim 21, wherein the event type of the detected obstruction event is an event type from a plurality of predefined event types, comprising:
a weather condition present at a position of a road, the weather condition comprising rain, fog, sleet or snow;
a person located at a position of the road;
an object located at a position of the road;
a road condition present at a position of the road, the road condition comprising a pothole, an icy road surface, or a missing road marking;
a natural disaster present at a position of the road, the natural disaster comprising a landslide; and/or
another road user driving in a wrong direction of travel.

27. The method according to claim 21, further comprising:
receiving data relating to the obstruction event; and
detecting the obstruction event based on the received data.

28. The method according to claim 27, wherein the data comprises Real Time Traffic Information (RTTI) data, a vehicle-to-vehicle message, or a vehicle-to-infrastructure message.

29. The method according to claim 21, further comprising:
outputting a takeover request to a driver of the vehicle before reaching the determined spatial extent of the obstruction region for the detected obstruction event, and to deactivate the automated driving function at a beginning of the determined spatial extent of the obstruction region;
preventing the automated driving function from being able to be activated as long as the vehicle is within the determined spatial extent of the obstruction region for the detected obstruction event; and/or outputting a takeover request to the driver of the vehicle and to deactivate the automated driving function after expiry of a predefined transfer period.

30. The method according to claim 29, wherein expiry of the predefined transfer period corresponds to the vehicle already being within the determined spatial extent of the obstruction region for the detected obstruction event.
